(19) United States
(12) Patent Application Publication
(10) Pub. No.: US 2015/0251270 A1
(43) Pub. Date: Sep. 10, 2015

(54) ELECTRODE FOR ELECTRODE HOLDER

(71) Applicant: KME GERMANY GMBH & CO. KG, Osnabrück (DE)

(72) Inventors: Hans-Günter Wobker, Bramsche (DE); Dirk Rode, Osnabrück (DE); Christof Dratner, Osnabrück (DE); Hark Schulze, Hasbergen (DE)

(73) Assignee: KME GERMANY GMBH & CO. KG, Osnabrück (DE)

(21) Appl. No.: 14/433,559

(22) PCT Filed: Oct. 2, 2013
(86) PCT No.: PCT/DE2013/000563

§ 371 Date: Apr. 3, 2015

(30) Foreign Application Priority Data
Oct. 5, 2012 (DE) 10 2012 019 555.9

(51) Int. Cl. B23K 11/30; C22C 9/00; H01B 1/02; C22C 9/02; C22C 9/10; C22C 9/06; B23K 35/22; C22C 9/04

(52) U.S. Cl. CPC B23K 11/3018; B23K 35/222; C22C 9/00; C22C 9/04; C22C 9/02; C22C 9/10; C22C 9/06; H01B 1/026

(57) ABSTRACT

An electrode for an electrode holder includes an electrode shaft having a terminal welding cap which is detachably secured to a cap holder of the electrode shaft. The cap holder and the welding cap consist of a copper material. The copper material of the cap holder has a greater strength and/or hardness than the copper material of the welding cap.

The invention relates to an electrode for an electrode holder including an electrode shaft having a terminal welding cap, which is detachably fastened on a cap holder of the electrode shaft.

Electrode holders have an at least two part construction in the region of the electrodes. The so-called welding cap is the component, which during the welding process comes into contact with the components to be welded. The welding caps are subject to thermal and mechanical stresses, which are caused by the welding process. As a consequence of the resulting plastic deformation and softening the welding caps are reworked in regular intervals and exchanged after reaching the wear limit.

The welding caps are usually attached onto a conical pin. The angle of the cone is selected so that a self-inhibition occurs so that the caps don not fall off. In addition they are always subject to stress in longitudinal direction of the cone so that the welding caps are securely and tightly attached. The tightness in the region of the cone is important because the welding cap is cooled from the inside with water. The water is supplied via the conical cap holder at the electrode shaft.

It has been shown that the cone, which is configured as tight fit, undergoes wear during a change of the welding caps. The reason for this is that the electrode caps have a hardness of 140 HBW 2.5/62.5 to 170 HBV 2.5/62.5, while the electrode shafts, which are usually made of the alloy CuCr1Zr, generally have hardnesses of between 130 HBV 2.5/62.5 to 160 HBV 2.5/62.5. As a result, during exchange of the electrodes abrasive wear occurs not on the welding cap but on the cap holder. Also, the welding caps are attached so securely that they have to be rotated off with a tool, which leads to wear marks on the cap holder in circumferential direction of the cone. When in spite of the wear a new electrode cap is attached, leakages may occur which then requires exchanging the entire electrode shaft and thus the entire electrode.

The invention is based on the object to set forth an electrode for an electrode holder which is less sensitive to wear compared to known electrodes and has a longer service life.

This object is solved with an electrode with the features of patent claim 1.

Advantageous refinements are the subject matter of the dependent claims.

The electrode according to the invention for an electrode holder includes an electrode shaft with a terminal welding cap, which is detachably fastened on a cap holder of the electrode shaft. The cap holder and the welding cap are made of a copper material, wherein the copper material of the cap holder has a greater strength than the copper material of the welding cap. As a result of the different strengths of the copper materials it is not the cap holder that is damaged when exchanging the welding cap but the welding cap. The strengths are therefore related inversely to each other compared to the state of the art.

The invention also has the advantage that not the entire electrode shaft has to have a greater strength than the welding cap but only the cap holder. The electrode shaft can be made of a material that is different from that of the welding cap. Preferably it is also a copper material.

An important aspect of the invention is that the region that may undergo wear in the region of the electrode shaft, i.e., the cap holder, has a sufficient resistance against mechanical influences as far as technically possible, in particular while retaining a highest possible conductivity. This is possible by selecting an appropriate pairing of copper materials. With the selection of materials according to the invention even dispersion materials with embedded hard materials can be used for the welding cap, without resulting in significant damage to the cap holder.

The advantages of the invention come to bear in particular when the copper material of the cap holder not only has the same or greater strength than the copper material of the welding cap, but also an at least equal hardness. When F1 and H1 represent the strength and hardness of the copper material of the cap holder and F2 and H2 represent the strength and hardness of the copper material of the welding cap the following relationships are to be satisfied:

F1≧F2

and/or

H1≧H2.

In particular the hardness of the welding cap is to be in a range of 160 HBV 2.5/62.5 to 180 HBV 2.5/62.5. The hardness of the cap holder is to be on average within a greater hardness range. It is preferably 180 HBV 2.5/62.5 to 220 HBV 2.5/187.5. In particular the hardness of the cap holder is above 190 HBV. The difference in hardness of 10 HBV to 30 HBV ensures that when exchanging the wear cap the mechanical stress mostly affects the welding cap and does not lead to damage to the surface of the cap holder.

The material that can be used for the electrode shaft includes highly conductive and also high-strength copper materials. A factor in selecting the material is whether the electrode shaft is subject to compressive stress as in the case of a straight electrode shaft, or whether the electrode shaft is bent and is thus subject to bending stress. it is important to note that the welding cap is exposed to a high thermal stress so that the welding cap has to be made of a hardenable and with this heat-resistant copper alloy. In hardenable materials, however, the specific electric conductivity is lower and with this the current consumption is higher than in pure copper qualities. The specific conductivity in CuCrZr is 45 MS/m to 50 MS/m. In a preferred more wear resistant tool such as CuNiSiCr the specific electric conductivity is about 25 MS/m to 30 MS/m. However, the arrangement according to the invention makes it possible to use a hardenable copper material only for the front part of the electrode, i.e., for the electrode cap and optionally for the electrode holder and to use a pure copper material with conductivities greater than 54 MS/m to greater than 58.5 MS/m, for example CuAg, Cu—ETP, Cu—OFE or Cu—HCP for the rear part , i.e., the significantly longer electrode shaft.

The rear part of the electrode shaft is virtually not subject to thermal stresses do not. The mechanical stress on the rear part may range between small and high depending on the construction. Typical compression forces during welding processes are in the range of 4.5 kN. The compression stress in straight electrode shafts is often only about 5 MPa, assuming an outer diameter of a circular electrode shaft of 35 mm and an inner diameter of 12 mm.

Depending on the application, electrode shafts can thus be made of a highly conductive copper material, selected for example from the following group of materials:

Cu—OF and Cu—OFE, i.e., highly pure and oxygen-free copper, which does not contain any elements that are evaporable in a vacuum and has a high conductivity for electricity and heat. Also suitable is Cu—ETP, i.e., oxygen-containing copper which has been produced by electrolytic refinement and which has a very high conductivity. Also suitable are Cu—HCP (HCP=High Conductivity Phosphorous), Cu—PHC (PHC=Phosphorous Deoxidized High conductivity Copper), DLPS—Cu (DLPS=Deoxidized Low Phosphorous Silver Bearing Copper), CuAg0.1P, CuFeP with 0.02-4.0 weight % iron (Fe) and 0.01-0.5 weight % Phosphorus (P), CuCr with 0.2-2.0 weight % chromium (Cr), CuZr with 0.02-0.5 weight % zirconium (Zr), CuZn with 0.05-4.0 weight % zinc (ZN) or CuSn with 0.05-11.0 weight % tin (Sn) or CuMg with 0.05-1.5 weight % magnesium (Mg).

Also high-strength copper materials selected from the following group of materials can be used for the electrode shaft:

CuCrZr with 0.2-2.0 weight % chromium (Cr) and 0.01-0.8 weight % zirconium (Zr), CuNiSi with 0.5-4.0 weight % nickel (Ni) and 0.1-2.0 weight % silicone (Si), CuCo Be with 0.5-4.0 weight % cobalt (Co) and 0.1-1.0 weight % beryllium (Be), CuNiCoBe with 0.5-3.0 weight % nickel and 0.5-3.0 weight % Cobalt (Co) and 0.1-1.5 weight % beryllium (Be), CuNiBe with 0.5-3.0 weight % nickel (Ni) and 0.1-1.0 weight % beryllium (Be), or CuNiP with 0.5-2.5 weight % nickel (Ni) and 0.05-0.75 weight % phosphorous.

The cap holder is preferably made of a material selected from the following group of materials: CuNiP with 0.5-2.5 weight % nickel (Ni) and 0.05-0.75 weight % phosphorous (P), CuNiSi with 0.5-4.0 weight % nickel (Ni) and 0.1-2.0 weight % silicone (Si), CuNiBe with 0.5-3.0 weight % nickel (Ni) and 0.1-1.0 weight % beryllium (Be), CuCoBe with 0.5-4.0 weight % cobalt (Co) and 0.1-1.0 weight % beryllium (Be) or CuNiCoBe with 0.5-3.0 weight % nickel (Ni) and 0.5-3.0 weight % cobalt (Co) and 0.1-1.5 weight % beryllium (Be).

All indicated amounts contain smelting related impurities within ranges that are technically.

In the case of a material combination of wear resistant cap holder and an electrode shaft the strength of the electrode shaft can be achieved also by a pure cold forming and/or a solid solution hardening and/or by precipitation hardening and a combination of the three methods.

The invention in particular provides an electrode shaft made of a wear-resistant copper material, which has a high hardness. This applies in particular to the cap holder, which can be made of the same material and in one piece with the electrode shaft or can be connected as separate component with the electrode shaft and can therefore be made of the same or a different material. In particular the cap holder is made of a wear-resistant material, in particular a material with a higher strength and/or hardness than the electrode shaft.

For this reason the aforementioned material can, depending on the application, contain one or more additional alloy components, selected from the following group. Insofar as the alloy components included in the following group are already contained in the aforementioned alloys, the originally stated alloy ranges apply. The alloy components in question are within the stated limit:

| | |
|---|---|
| Phosphorous (P) | 0.001-0.05 weight % |
| Manganese (Mn) | 0.01-0.8 weight % |
| Chromium (Cr) | 0,01-0.5 weight % |
| Aluminum (Al) | 0.01-0.5 weight % |
| Magnesium (Mg) | 0.01-0.5 weight % |
| Iron (Fe) | 0.01-0.5 weight % |
| Zinc (Zn) | 0.01-2.5 weight % |
| Zirconium (Zr) | 0.01-0.5 weight % |
| Tin (Sn) | 0.01-2.5 weight % |
| Silver (Ag) | 0.01-0.5 weight % |

Regarding the additional alloy components it is noted that phosphorus serves as deoxidizing agent, which binds the free oxygen dissolved in the melt and thus prevents gas bubbles (also known as hydrogen embrittlement) and oxidation of alloy components. Phosphorous is also added in order to improve the flow properties of the copper alloy during casting.

Manganese refines the grain and in combination with sulfur improves machinabiltiy or respectively prevents a phase formation of the sulfur with the alloy elements of the corresponding alloy type. Manganese also serves as deoxidizing agent.

Aluminum increases the hardness and yield strength without decreasing tenacity. Aluminum is an element, which improves the strength, workability and wear resistance and the oxidation resistance at high temperatures.

Chromium and magnesium serve improving the oxidation resistance at high temperatures. Particularly good results are herby achieved when these elements are mixed with aluminum in order to achieve a synergistic effect.

Iron increases the corrosion resistance and together with phosphorous forms iron phosphide phases for increasing hardness.

Zirconium improves the hot formability.

Tin increases the solid solution hardening.

Silver increases the recrystallization temperature without significantly decreasing conductivity.

The multipart construction of the electrode can be achieved by a detachable connection between the cap holder and the electrode shaft. The welding cap itself remains an exchangeable part. The connection between the cap holder and the welding cap is thus preferably always a detachable connection. However, because there are two possible interfaces for detachable connections, i.e., on one hand between the cap holder and the welding cap, and on the other hand between the cap holder and the electrode shaft, it is possible to exchange the cap holder together with the welding cap if needed, in case the welding cap cannot be removed for certain reasons of in case the cap holder is worn.

The connection between the cap holder and the electrode shaft is in particular a screw connection. Screw connections can be realized simply and cost effectively and enable in the case of appropriate tightening torques a sufficient fit for the type of stress at hand. In addition screw connections can also create the required tightness.

In addition a sealing disc, preferably made of copper or a copper alloy, can be introduced in the screw connection, in order to ensure the tightness of the connection. The sealing disc can be made of the aforementioned copper materials or copper alloys.

In a preferred embodiment, the cap holder has on one end a thread section for the screw connection with the electrode shaft and on its other end a cone as push-on mount of the welding cap. Hereby the thread section and the cone are arranged aligned to each other. During welding the longitudinal direction of the cap holder corresponds to the direction of force introduction so that the thread section is not exposed to bending stress. At the same time the welding cap is firmly pressed against the cone and is thereby securely held on the cone.

In the cap holder is a cooling channel is situated, which extends in the longitudinal direction of the cap holder. This allows a cooling liquid reaching the welding cap in order to dissipate heat generated during the welding process.

In addition a sealing disc can be arranged between the cap holder and the welding cap and/or between the cap holder and the electrode shaft, in particular when screw connections are present,

In an alternative embodiment it is possible to non-detachably connect the cap holder with the electrode shaft. Possible joining methods are preferably those with low heat introduction. These can include brazing or soldering processes. Also arc beam welding processes such as laser and electron beam welding are possible. Also a combination of these processes is possible, and also a combination by means of WIG welding. The exchangeability of the cap holder however is primarily enabled by a detachable connection, thus constituting the preferred embodiment.

In the following the invention is described in more detail by way of an exemplary embodiment shown in the drawings. It is shown in:

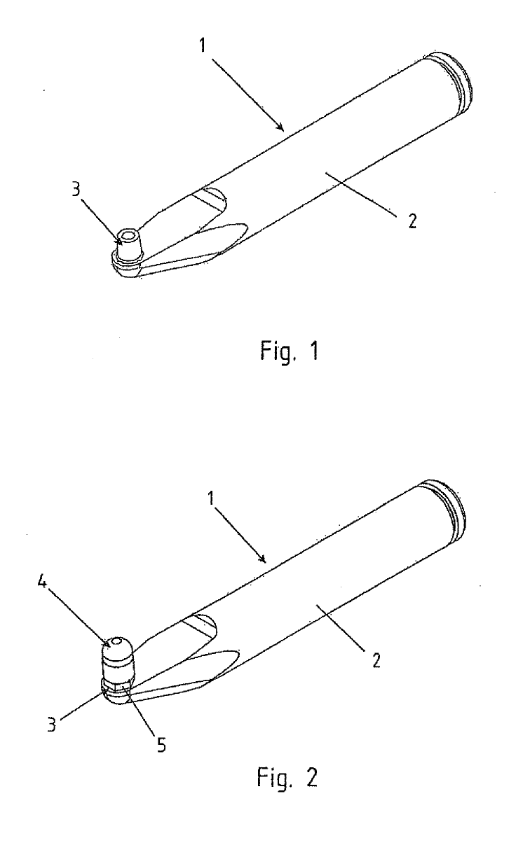

FIG. 1 an electrode in conventional construction (state of the art)

FIG. 2 an electrode according to the invention;

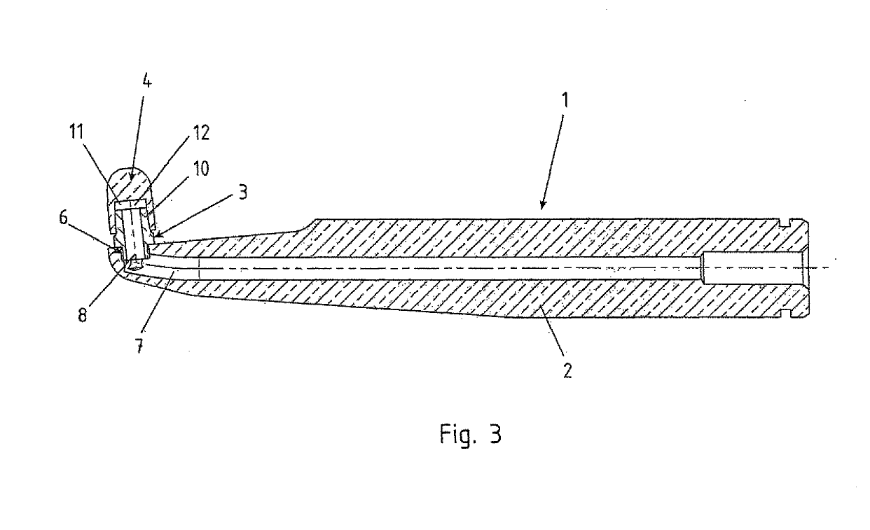

FIG. 3 a longitudinal section through the electrode of FIG. 2;

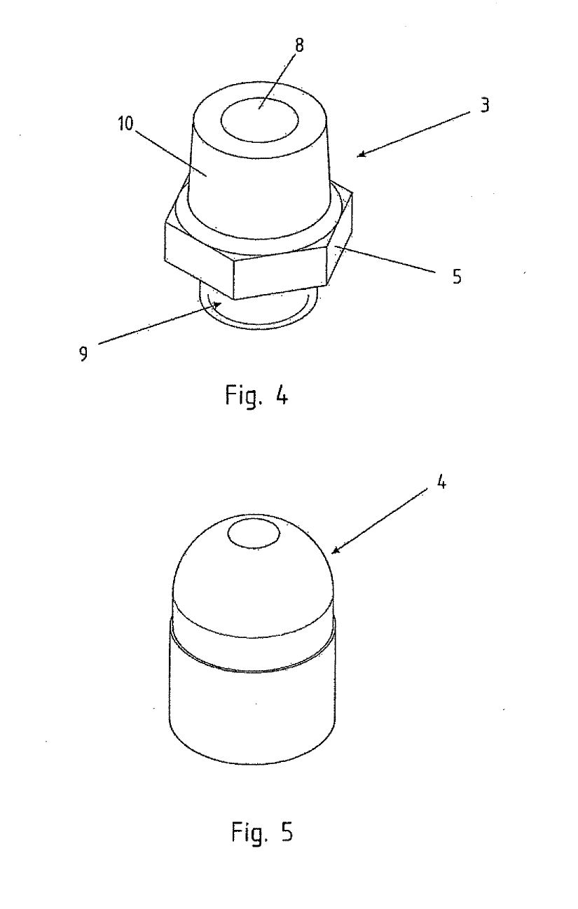

FIG. 4 a cap holder in a perspective view and

FIG. 5 a welding cap in a perspective view.

FIG. 1 shows an electrode for a not further shown electrode holder. The electrode holder includes a further not further shown, electrode, which may be of identical construction. The shown electrode is configured one-piece and includes a longitudinal cylindrical electrode shaft 2, which has a pointed conical extend on one end, and a so-called cap holder 3 in form of a transversely protruding conical hollow pin. In the representation of FIG. 1 this hollow pin protrudes upwards. Its diameter is smaller than the one of the electrode shaft 2. It serves for receiving a not further shown welding cap, which as counterpart has a conical receptacle and is pushed onto the cap holder. The electrode shaft 2 has a coolant channel and on its inside is connected with a cooling channel in the cap holder 3 so that a coolant can be conducted on the inside up to the cap holder 3 which serves for cooling the welding cap. This serves dissipating heat during welding. The cap holder 3 is made of the same material as and formed one-piece with the electrode shaft. When the cap holder 3 is worn in the region of its outer cone, the entire electrode shaft 2, and with this the entire electrode 1, has to be exchanged.

The embodiment of the electrode according to the invention according to FIG. 2 on the other hand provides for a multipart configuration. In the following the same reference signs introduced in FIG. 1 are used for substantially the same components. The electrode 1 according to the invention includes a substantially cylindrical electrode shaft 2, which narrows at one end and also a cap holder 3 which protrudes transversely relative to the longitudinal direction of the electrode shaft 2 and onto which a welding cap 4 is attached. In FIG. 2 only one tool-engagement surface 5 of the cap holder 3 can be recognized. Here a hextool can be attached in order to screw the cap holder 3 into the electrode shaft 2. Details thereof can be recognized in FIG. 3.

FIG. 3 shows the components of the electrode 1 according to the invention made of different copper materials. In this exemplary embodiment the electrode shaft 2 is made of a highly conductive copper material, for example of the material groups Cu—OF, Cu—OFE, Cu—ETP, Cu—HCP, Cu—PLP, Cu—PHC, DLPS—Cu or CuAg01P. Beside the welding cap 4, the cap holder 3 has to be the most wear-resistant component of the electrode. It can be recognized that the cap holder 3 is screwed into the electrode shaft 2 via a screw connection. Hereby a tight connection between a coolant channel 7 inside the electrode shaft 2 and a cooling channel 8, which traverses the entire cap holder 3, is created.

FIG. 4 shows an enlarged representation of the cap holder 3 with its thread section 9 in the foot region and the adjoining tool-engagement surface 5 in the form of an outer hexagon. Adjoining thereon is a pin (cone 10) with a conical outside, onto which the welding cap can be pushed as it is shown in FIG. 5. The welding cap 4 shows in the assembled position that it has a conical opening at its bottom side, wherein the conicity of the opening matches the cone 10 of the cap holder 3. A free space 11 between the front side of the cone 10 and the deepest point of the conical receptacle 12 prevents that the welding cap 4 sits on the cap holder 3. This is in any case a clamping connection, In addition the coolant flows through the free space 11, so that a greater heat transmission surface between the coolant and the welding cap 4 is created in order to enable an effective dissipation of heat. The taper between the cap holder 3 and the welding cap 4 is preferably 1:10.

The welding cap 4 in FIG. 5 has for example a height of 22 mm and a diameter of 16 mm. The welding cap is rounded in a half circular shape in its upper half and at is flattened at the tip in a diameter range of about 5 mm. The bottom part of the welding cap adjoins the rounded upper half in a cylindrical shape and in the inside severs for forming the conical receptacle 12, as shown in FIG. 3.

### REFERENCE SIGNS

1—electrode
2—electrode shaft
3—cap holder
4—welding cap
5—tool engagement surface
6—screw connection
7—coolant channel
8—coolant channel
9—thread section cone
11—free space
12—receptacle

What is claimed is:

1-12. (canceled)

13. An electrode for an electrode holder, comprising:
an electrode shaft having a cap holder provided at an end of the electrode shaft; and
a welding cap detachably fastened on the cap holder, wherein the cap holder and the welding cap are made of a copper material, and wherein the copper material of the cap holder has a strength F1 and a hardness H1 and the copper material of the welding cap has a strength F2 and a hardness H2, and wherein F1≧F2 and/or H1≧H2.

14. The electrode of claim 13, wherein the hardness of the welding cap is within a range from 160 to 180 HBV and the hardness of the cap holder is above 180 HBV to 220 HBV.

15. The electrode of claim 13, wherein the electrode shaft is made of a conductive copper material selected from a member of the group consisting of Cu—OF, Cu—OFE, Cu—ETP, Cu—HCP, Cu—DLP, Cu—PHC DLPS—Cu, CuAg0.1P, CuFeP with 0.02-4.0 weight % Fe and 0.01-0.5 weight % P, CuCr with 0.2-2.0 weight % Cr, CuZr with 0.02-0.5 weight % Zr, CuZn with 0.05-4.0 weight % Zn or CuSn with 0.05-11.0 weight % Sn and CuMg with 0.05-1.5 weight % Mg.

16. The electrode of claim 13, wherein the electrode shaft is made of a high-strength copper material selected from the group of materials consisting of CuCrZr with 0.2-2.0 weight % Cr and 0.01-0.8 weight % Zr, CuNiSi with 0.5-4.0 weight % Ni and 0.1-2.0 weight % Si, CuCoBe with 0.5-4.0 weight % Co and 0.1-1.0 weight % Be, CuNiCoBe with 0.5-3.0 weight % Ni and 0.5-3.0 weight % Co and 0.1-1.5 weight % Be, CuNiBe with 0.5-3.0 weight % Ni and 0.1-1.0 weight % Be and CuNiP with 0.5-2.5 weight % Ni and 0.05-0.75 weight % P.

17. The electrode of claim 13, wherein the cap holder is made of a material selected from a member of the group consisting of CuNiP with 0.5-2.5 weight % Ni and 0.05-0.75 weight % P, CuNiSi with 0.5-4.0 weight % Ni and 0.1-2.0 weight % Si, CuNiBe with 0.5-3.0 weight % Ni and 0.1-1.0 weight % Be, CuCoBe with 0.5-4.0 weight % Co and 0.1-1.0 weight % Be, and CuNiCoBe with 0.5-3.0 weight % Ni, 0.5-3.0 weight % Co and 0.1-1.5 weight % Be.

18. The electrode of claim 15, wherein the member optionally contains one or more of the following alloy elements:

| | |
|---|---|
| Phosphorous (P) | 0.001-0.05 weight % |
| Manganese (Mn) | 0.01-0.8 weight % |
| Chromium (Cr) | 0.01-0.5 weight % |
| Aluminum (Al) | 0.01-0.5 weight % |
| Magnesium (Mg) | 0.01-0.5 weight % |
| Iron (Fe) | 0.01-0.5 weight % |
| Zinc (Zn) | 0.01-2.5 weight % |
| Zirconium (Zr) | 0.01-0.5 weight % |
| Tin (Sn) | 0.01-2.5 weight % |
| Silver (Ag) | 0.01-0.5 weight % |

19. The electrode of claim 13, wherein the cap holder is detachably connected with the electrode shaft.

20. The electrode of claim 13, wherein the cap holder is connected with the electrode shaft via a screw connection.

21. The electrode of claim 13, wherein an end of the cap holder is provided with a thread section for threaded engagement with the electrode shaft via the screw connection, and another end of the cap holder is provided with a cone as push-on mount for the welding cap, wherein the thread section and the cone are arranged so as to be aligned with each other.

22. The electrode of claim 21, wherein a coolant channel is arranged in the cap holder, and extends in longitudinal direction of the cap holder.

23. The electrode of claim 13, further comprising a sealing disc arranged between the cap holder and the welding cap and/or between the cap holder and the electrode shaft.

24. The electrode of claim 13, wherein the cap holder is non-detachably connected with the electrode shaft.
